(19) United States
(12) Patent Application Publication
(10) Pub. No.: US 2002/0166986 A1
(43) Pub. Date: Nov. 14, 2002

(54) Remote controlled fluid valve

(76) Inventors: Thomas D. Remby, Woodland Hills, CA (US); James R. Remby, Hopkinton, MA (US)

Correspondence Address: Polster, Lieder, Woodruff & Lucchesi, L.C., 763 South New Ballas Road, St. Louis, MO, 63141, US

(21) Appl. No.: 09/852,851

(22) Filed: May 10, 2001

(51) Int. Cl. F16K 31/02

(52) U.S. Cl. 251/129.04

(57) ABSTRACT

A remote controlled fluid valve for attaching between a source of fluid and a hose comprises a receiver valve assembly comprising a faucet engaging end, a hose engaging end, a conduit body between the faucet engaging end and the hose engaging end, a solenoid valve mated to the conduit body with the solenoid valve controlling any flow of fluid through the conduit body, a receiver connected to the solenoid valve for controlling operation of the solenoid valve, and a transmitter for transmitting a signal to the receiver to control operation of the solenoid valve.

### BACKGROUND OF THE INVENTION

This invention relates to a remote controlled fluid valve, and more particularly, to a remote controlled fluid valve which connects directly between a faucet and a hose which is used to control the flow of water between the faucet and the hose.

In order to water a lawn or a garden at a home or residence, it is common to have a hose connected to a water faucet with the faucet being located at a side of a house. Additionally, the hose may be connected to a reel assembly to facilitate winding, unwinding, and storage of the hose. Typically, the hose is moved from side to side on the ground in an effort to water different portions of the lawn or yard. Further, most homes have more than one faucet in order to allow a homeowner the opportunity to use more than one hose in order to water different parts of the yard. For example, it would be desirable to water the front yard using one hose while at the same time watering the backyard using a different hose. If the house and yard are very large, then it is possible that there are more than two faucets and more hoses will have to be employed to completely water the yard at the same time. As can be appreciated, turning on and off multiple faucets takes time and effort. A homeowner would be required to go from faucet to faucet in order to operate each faucet. Additionally, it is a common occurrence for a homeowner to reposition a sprinkler attached to a hose. In order to verify the positioning of the sprinkler, the homeowner must walk back to the faucet to turn the water on, then repeat this step if the sprinkler is improperly positioned. There are times when it would be advantageous to be able to remotely control the operation of each faucet without having to travel to the faucet to manually adjust or control such faucet.

Further, it is also known that a number of residences have an inground sprinkler system which has one or more zones for watering specific areas of a lawn. Typically a main control unit is employed to control the various zones. For example, the main control unit may be programmed to water any zone at any time for any duration of time. Other known irrigation systems, such as agricultural and industrial sprinkler systems, are controlled using AC (alternating current) wires that are buried in the ground. Such systems are expensive to install and maintain and are also subject to regulatory restrictions.

The present invention is designed to obviate and overcome many of the disadvantages and shortcomings associated with presently available faucets. In particular, the present invention is a remote controlled fluid valve which is constructed to allow a user to remotely control operation of a faucet. Moreover, the remote controlled fluid valve of the present invention can be employed to easily control the operation of an existing faucet.

### SUMMARY OF THE INVENTION

In one form of the present invention, a remote controlled fluid valve for attaching between a source of fluid and a hose, the remote controlled fluid valve comprising a receiver valve assembly comprising a faucet engaging end, a hose engaging end, a conduit body between the faucet engaging end and the hose engaging end, a solenoid valve mated to the conduit body with the solenoid valve controlling any flow of fluid through the conduit body, a receiver connected to the solenoid valve for controlling operation of the solenoid valve, and a transmitter for transmitting a signal to the receiver to control operation of the solenoid valve.

In another form of the present invention, a remote controlled fluid valve for attaching between a faucet and a hose comprises a receiver valve assembly comprising a faucet engaging end, a hose engaging end, a conduit body between the faucet engaging end and the hose engaging end, a solenoid valve mated to the conduit body with the solenoid valve controlling water flow through the conduit body, a receiver connected to the solenoid valve for controlling operation of the solenoid valve, a container for housing the solenoid valve and the receiver, and a transmitter for transmitting a signal to the receiver to control operation of the solenoid valve.

In yet another form of the present invention, a first remote controlled fluid valve for attaching between a source of fluid and a first comprises a receiver valve assembly comprising a faucet engaging end, a hose engaging end, a conduit body between the faucet engaging end and the hose engaging end, a solenoid valve mated to the conduit body with the solenoid valve controlling any flow of fluid through the conduit body, a receiver connected to the solenoid valve for controlling operation of the solenoid valve, a second remote controlled fluid valve for attaching between the source of fluid and a second hose comprises a receiver valve assembly comprising a faucet engaging end, a hose engaging end, a conduit body between the faucet engaging end and the hose engaging end, a solenoid valve mated to the conduit body with the solenoid valve controlling any flow of fluid through the conduit body, a receiver connected to the solenoid valve for controlling operation of the solenoid valve, and a transmitter for transmitting a first signal to the receiver of the first remote controlled fluid valve and a second signal to the receiver of the second remote controlled fluid valve to control operation of the solenoid valves.

In light of the foregoing comments, it will be recognized that a principal object of the present invention is to provide a remote controlled fluid valve which is of simple construction and design and which can be easily employed with highly reliable results.

Another object of the present invention is to provide a remote controlled fluid valve which is of unitary construction and which does not require any modification to an existing hose.

A further object of the present invention is to provide a remote controlled fluid valve which is capable of operation from a remote location.

Another object of the present invention is to provide a remote controlled fluid valve which does not require any modification to an existing water faucet and is easily connected to a water faucet.

A still further object of the present invention is to provide a system which employs one or more of the remote controlled fluid valves of the present invention for watering a large area.

Another object of the present invention is to provide a system of remote controlled fluid valves which does not require wiring and can be controlled remotely.

A further object of the present invention is to provide a system of remote controlled fluid valves which can be operated separately and can be controlled by a timer.

Another object of the present invention is to provide an improved remote controlled irrigation system which is of simple design and construction.

These and other objects and advantages of the present invention will become apparent after considering the following detailed specification in conjunction with the accompanying drawings, wherein:

### BRIEF DESCRIPTION OF THE DRAWINGS

FIG. 1 is a perspective view of a preferred embodiment of a remote controlled fluid valve constructed according to the present invention;

FIG. 2 is an enlarged side view of the remote controlled fluid valve shown in FIG. 1;

FIG. 3 is a top view of the remote controlled fluid valve shown in FIG. 2;

FIG. 4 is a perspective view of the remote controlled fluid valve shown in FIG. 1 with an outer container and a lid removed;

FIG. 5 is a partial cross-sectional view of a receiver valve assembly of the remote controlled fluid valve constructed according to the present invention;

FIG. 6 is a perspective view of the outer container including some of the components housed within the container; and

FIG. 7 is a block diagram of a system employing several of the remote controlled fluid valves.

### DETAILED DESCRIPTION OF THE PREFERRED EMBODIMENTS

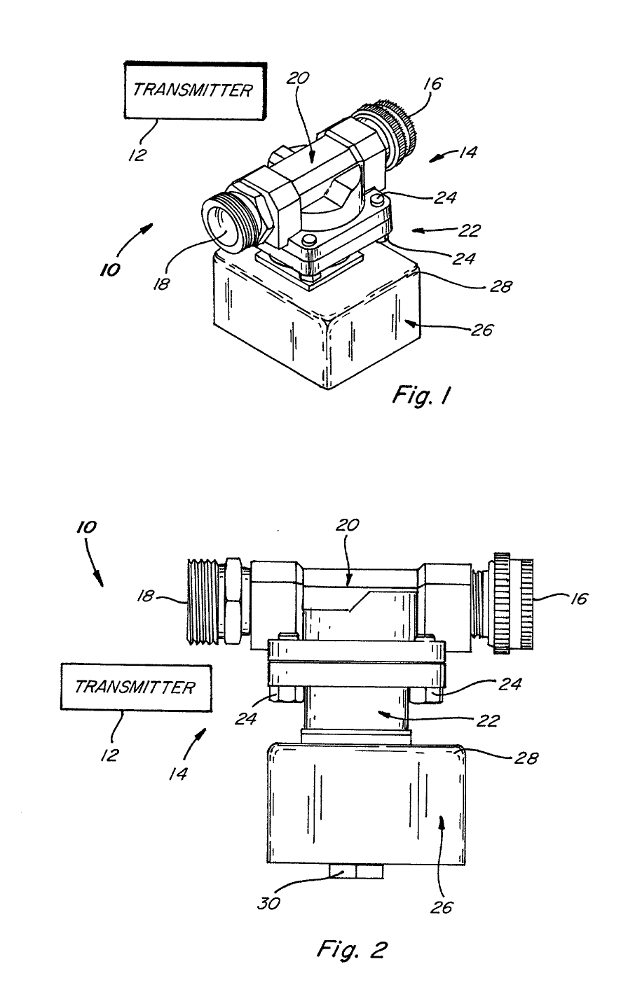

Referring now to the drawings, wherein like numbers refer to like items, number 10 identifies a preferred embodiment of a remote controlled fluid valve 10 constructed according to the present invention. With reference now to FIGS. 1, 2, and 3, the remote controlled fluid valve 10 is shown comprising a transmitter 12 and a receiver valve assembly 14. The transmitter 12 is capable of transmitting a signal, such as a coded signal, which is received by the receiver valve assembly 14. The receiver valve assembly 14 has a faucet engaging end 16 and a hose engaging end 18. The receiver valve assembly 14 is adapted to be connected between a faucet (not shown) and a hose (not shown) with the faucet supplying water to the faucet engaging end 16 through the receiver valve assembly 14 out of the hose engaging end 18 into the hose. In this manner, the receiver valve assembly 14 is used to provide water to a hose in order to water a lawn or a garden.

The receiver valve assembly 14 further comprises a conduit body 20 between the faucet engaging end 16 and the hose engaging end 18. The conduit body 20 is mated to a solenoid valve 22 by use of threaded bolts 24. The receiver valve assembly 14 further includes an outer container or housing 26 and a lid 28 which cover the solenoid valve 22. The container 26 is separable from the lid 28 in order to gain access into the container 26. A retaining nut 30 is also used to hold the container 26 to the lid 28. Once the retaining nut 30 is removed, the container 26 may be easily separated from the lid 28. The retaining nut 30 may be screwed or threaded on to the solenoid valve 22.

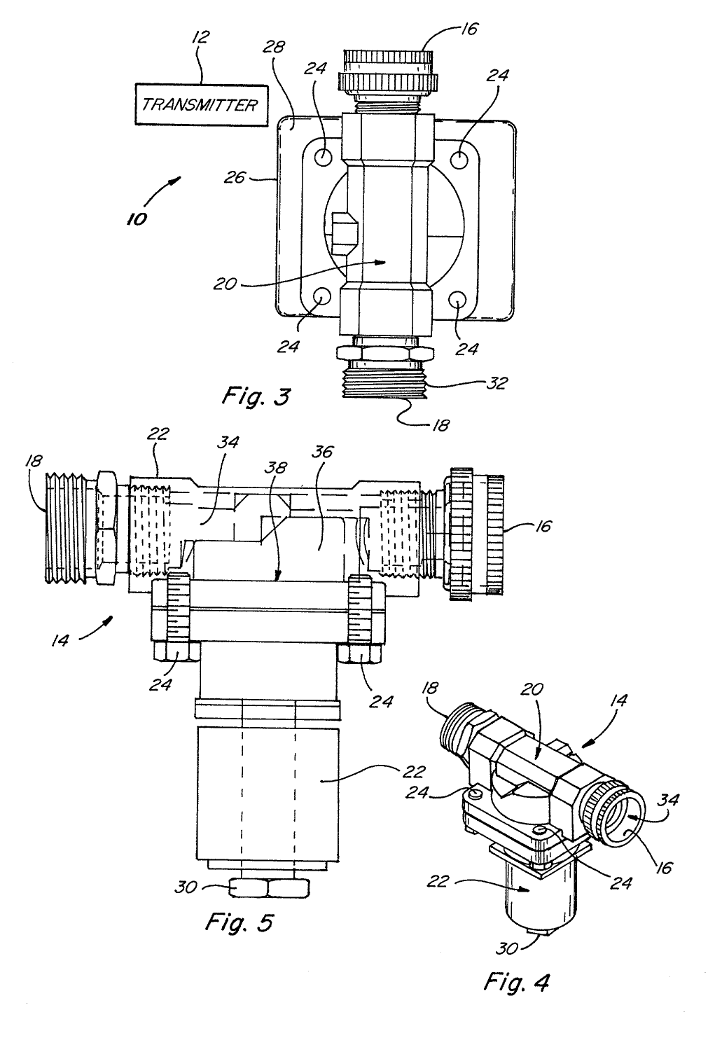

With particular reference to FIG. 3, the faucet engaging end 16 is depicted having the end 16 which is adapted to be rotated into place on a water faucet. The hose engaging end 18 includes threads 32 which are sized and shaped to receive the end of a hose. In operation, the faucet engaging end 16 is connected directly to a faucet and the hose engaging end is connected directly to a hose. The faucet is turned on to allow water to flow and the solenoid valve 22 is in its normally closed position which restricts the flow of water through the receiver valve assembly 14. When the transmitter 12 is operated, a signal is sent to the receiver valve assembly 14 which opens the solenoid valve 22 to allow water to flow through the receiver valve assembly 14 to the hose.

Referring now to FIG. 4, a perspective view of the receiver valve assembly 14 is shown with the container 26 and the lid 28 being removed. The receiver valve assembly 14 has the faucet engaging end 16 and the hose engaging end 18. The receiver valve assembly 14 is further shown to have the conduit body 20 which also has a conduit 34 through which fluid, such as water, is able to pass or flow. The conduit body 20 is mated to the solenoid valve 22 by use of the threaded bolts 24. Additionally, the retaining nut 30 is shown threaded onto the solenoid valve 22.

FIG. 5 illustrates a partial cross-sectional view of the receiver valve assembly 14. In particular, the receiver valve assembly 14 has the conduit 34 formed within the conduit body 20 for allowing water to flow from the faucet engaging end 16 to the hose engaging end 18. The solenoid valve 22 further comprises a valve member 36 which is inserted through an opening 38 in the conduit body 20 and the conduit 34. The valve member 36 is shown in the normally closed position and in this arrangement any fluid or water entering through the faucet engaging end 16 will be blocked or prevented from flowing through the conduit 34. The valve member 36 is also capable of being retracted into an opened position in which the valve member 36 will be moved enough to allow water to flow through the conduit 34. As can be appreciated, the valve member 36 can be controlled to be either opened or closed, or moved to any position therebetween. For example, the valve member 36 may be operated to be one quarter opened, which restricts the water flow. Additionally, the valve member 36 may be opened to a three quarters position, which still restricts the water flow but not as much as when the valve member 36 is in the one quarter opened position. In this manner, the valve member 36 may be partially opened to control the pressure of the water flow. Also, as indicated previously, the valve member 36 may only have two degrees of movement which are either opened or closed.

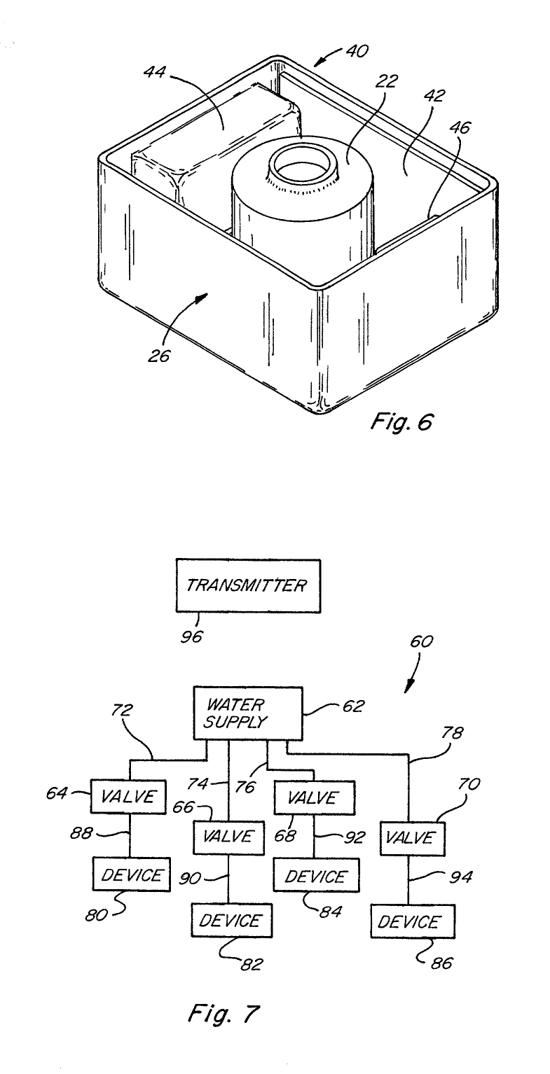

With reference now to FIG. 6, an interior view of the container 26 is shown. The container 26 is used to house the solenoid valve 22 along with a receiver portion 40. The receiver portion 40 includes a circuit board 42, a battery 44, such as a nine volt battery, and a capacitor 46. The circuit board 42 is electrically connected to the solenoid valve 22, although such connection is not shown. The circuit board 42 may include other components such as a coil which is used to receive signals sent from the transmitter 12 and associated circuitry for determining whether a signal has been received from the transmitter 12. The battery 44 is used to power the circuit board and its associated components, the solenoid valve 22, and the capacitor 46. The circuitry for the receiver portion 40 is well known and is not described in any further detail herein. The receipt of a signal from the transmitter 12 will be used to either open or close the solenoid valve 22. Also, a signal from the transmitter 12 may be used to partially open or close the valve member 36. Further, it is also possible that the receiver portion 40 may include circuitry which is only responsive to a coded signal from the transmitter 12. In this example, if more than one receiver valve assembly 14 is being used, it is possible to selectively control each of the receiver valve assemblies 14 by use of the transmitter 12. In this event, one receiver valve assembly 14 could be turned on and another receiver valve assembly 14 could be turned off all from a location remote from both of the receiver valve assemblies 14.

When the retaining nut 30 is removed from the solenoid valve 22, the container 26 is easily separated from the lid 28. Once separated from the lid 28, the battery 44 may be removed, if required, and a new battery 44 may be used or inserted. Additionally, the container 26 and the lid 28 are used to protect the solenoid valve 22, the receiver portion 40, the circuit board 42, the battery 44, and the capacitor 46 from water entering into the container 26.

The transmitter 12 has not be shown or discussed in any detail herein. Such transmitter 12 is well known and one example of such a transmitter 12 is a garage door type opener. As can be appreciated, the transmitter 12 may include a battery for powering the transmitter 12. Additionally, the transmitter 12 may be capable of transmitting different coded signals for remotely controlling more than one of the receiver valve assemblies 14. For example, the transmitter 12 may have one or more buttons which, when depressed, either opens or closes one of the receiver valve assemblies 14.

FIG. 7 depicts a system 60, such as an irrigation system, which can be constructed using one or more the remote controlled fluid valves. The system 60 includes a water supply 62 for supplying water to remote controlled fluid valves 64, 66, 68, and 70 via water supply lines 72, 74, 76, and 78, respectively. The valves 64-70 are similar to the receiver valve assembly 14. Each of the valves 64-70 is connected to an output device 80, 82, 84, and 86, respectively, by a water supply line 88, 90, 92, and 94. An example of the output devices 80-86 may be a sprinkler unit or head. A transmitter unit 96 controls the operation of the valves 64-70. The transmitter unit 96 may have a timer built in to further control the operation of the valves 64-70. For example, it is possible to program the transmitter unit 96 to send a signal to the valve 64 to actuate the valve 64 at a time different than the other valves 66-70. The transmitter unit 96 may be capable of transmitting coded signals which are unique to each of the valves 64-70. For example, a first coded signal may be used to actuate the valve 64 and a second coded signal may be used to actuate the valve 66. The transmitter unit 96 may also be a hand held device which may be carried around the system 60 to manually control operation of the system 60. For example, the transmitter unit 96 may be used to turn on or off any of the valves 64-70 as desired.

It should be recognized that the remote controlled fluid valve 10 of the present invention can be constructed of various materials and can be assembled from separable components. Preferably, the remote controlled fluid valve 10 will be of relatively lightweight material so that it can be easily constructed, assembled, positioned, employed, secured in place, and removed. Further, the remote controlled fluid valve 10 will be constructed of relatively inexpensive materials and components. Additionally, the remote controlled fluid valve 10 is easily connected to commonly available faucets and hoses and requires no new or modified faucets or hoses to be purchased or used. The receiver valve assembly 14 is easily connected between a faucet and a hose and when operated allows water to flow from the faucet to the hose. As can be appreciated, the device 10 provides remote control of the receiver valve assembly. If the hose is connected to a sprinkler device, a user can move or reposition the sprinkler device without having to make one or more trips to the faucet.

From all that has been said, it will be clear that there has thus been shown and described herein a remote controlled fluid valve which fulfills the various objects and advantages sought therefor. It will become apparent to those skilled in the art, however, that many changes, modifications, variations, and other uses and applications of the subject remote controlled fluid valve are possible and contemplated. All changes, modifications, variations, and other uses and applications which do not depart from the spirit and scope of the invention are deemed to be covered by the invention, which is limited only by the claims which follow.

What is claimed is:

1. A remote controlled fluid valve for attaching between a source of fluid and a hose, the remote controlled fluid valve comprising a receiver valve assembly comprising a faucet engaging end, a hose engaging end, a conduit body between the faucet engaging end and the hose engaging end, a solenoid valve mated to the conduit body with the solenoid valve controlling any flow of fluid through the conduit body, a receiver connected to the solenoid valve for controlling operation of the solenoid valve, and a transmitter for transmitting a signal to the receiver to control operation of the solenoid valve.

2. The remote controlled fluid valve of claim 1 wherein the receiver valve assembly further comprises a container for housing the solenoid valve and the receiver.

3. The remote controlled fluid valve of claim 2 wherein the receiver valve assembly further comprises a lid which is separable from the container and separation of the lid from the container allows access to the solenoid valve and the receiver.

4. The remote controlled fluid valve of claim 3 further comprising a retaining nut which is adapted to be inserted on the solenoid valve to retain the container and the lid together.

5. The remote controlled fluid valve of claim 1 wherein the receiver further comprises a battery for powering the receiver.

6. The remote controlled fluid valve of claim 1 wherein the conduit body has an opening and the solenoid valve has a valve member which is adapted for being inserted into the opening.

7. The remote controlled fluid valve of claim 6 wherein the valve member is capable of being partially inserted into the opening.

8. The remote controlled fluid valve of claim 1 wherein the signal is a coded signal which is transmitted and the receiver is capable of receiving the coded signal.

9. A remote controlled fluid valve for attaching between a faucet and a hose, the remote controlled fluid valve comprising a receiver valve assembly comprising a faucet engaging end, a hose engaging end, a conduit body between the faucet engaging end and the hose engaging end, a solenoid valve mated to the conduit body with the solenoid valve controlling water flow through the conduit body, a receiver connected to the solenoid valve for controlling operation of the solenoid valve, a container for housing the solenoid valve and the receiver, and a transmitter for transmitting a signal to the receiver to control operation of the solenoid valve.

10. The remote controlled fluid valve of claim 9 wherein the receiver valve assembly further comprises a lid which is separable from the container and separation of the lid from the container allows access to the solenoid valve and the receiver.

11. The remote controlled fluid valve of claim 10 further comprising a retaining nut which is adapted to be inserted on the solenoid valve to retain the container and the lid together.

12. The remote controlled fluid valve of claim 9 wherein the conduit body has an opening and the solenoid valve has a valve member which is adapted for being inserted into the opening.

13. The remote controlled fluid valve of claim 12 wherein the valve member is capable of being partially inserted into the opening.

14. The remote controlled fluid valve of claim 9 wherein the receiver further comprises a battery for powering the receiver.

15. The remote controlled fluid valve of claim 9 wherein the signal is a coded signal which is transmitted and the receiver is capable of receiving the coded signal.

16. A first remote controlled fluid valve for attaching between a source of fluid and a first hose, the first remote controlled fluid valve comprising a receiver valve assembly comprising a faucet engaging end, a hose engaging end, a conduit body between the faucet engaging end and the hose engaging end, a solenoid valve mated to the conduit body with the solenoid valve controlling any flow of fluid through the conduit body, a receiver connected to the solenoid valve for controlling operation of the solenoid valve, a second remote controlled fluid valve for attaching between the source of fluid and a second hose, the second remote controlled fluid valve comprising a receiver valve assembly comprising a faucet engaging end, a hose engaging end, a conduit body between the faucet engaging end and the hose engaging end, a solenoid valve mated to the conduit body with the solenoid valve controlling any flow of fluid through the conduit body, a receiver connected to the solenoid valve for controlling operation of the solenoid valve, and a transmitter for transmitting a first signal to the receiver of the first remote controlled fluid valve and a second signal to the receiver of the second remote controlled fluid valve to control operation of the solenoid valves.

17. The remote controlled fluid valve of claim 16 wherein the first signal and the second signals are coded signals and the receivers are capable of receiving the coded signals.

18. The remote controlled fluid valve of claim 16 wherein each of the receiver valve assemblies further comprises a container for housing the solenoid valve and the receiver.

19. The remote controlled fluid valve of claim 18 wherein each of the receiver valve assemblies further comprises a lid which is separable from the container and separation of the lid from the container allows access to the solenoid valve and the receiver.

20. The remote controlled fluid valve of claim 16 further comprising a plurality of remote controlled fluid valves and the receiver capable of controlling the operation of each of the valves.
